(19) United States
(12) Patent Application Publication
(10) Pub. No.: US 2023/0283499 A1
(43) Pub. Date: Sep. 7, 2023

(54) Enhanced Smart Home Services

(71) Applicant: AT&T Intellectual Property I, L.P., Atlanta, GA (US)

(72) Inventors: Zhi Li, Palo Alto, CA (US); Raghvendra Savoor, Walnut Creek, CA (US)

(73) Assignee: AT&T Intellectual Property I, L.P., Atlanta, GA (US)

(21) Appl. No.: 17/686,570

(22) Filed: Mar. 4, 2022

(51) Int. Cl. H04L 12/28; H04L 67/30; H04L 67/12

(52) U.S. Cl. CPC H04L 12/2803; H04L 67/30; H04L 67/12; G06N 20/00

(57) ABSTRACT

Concepts and technologies disclosed herein are directed to enhanced smart home services. According to one aspect disclosed herein, a home gateway device can capture, from a home device, home data associated with home user activity conducted via a fixed communications network. The home gateway device can determine, based upon the home data, a home data profile. The home gateway device can receive a mobility data profile determined by a mobility data profiler based upon mobility data associated with mobile user activity conducted via a mobile communications network. The home gateway device can determine, based upon the mobility data profile and the home data profile, a policy for the home device. In some embodiments, the home device is an IoT device. In other embodiments, the home device is a media device such as a television, a video streaming device, a music streaming device, or a video game device.

### BACKGROUND

Network providers may expose application programming interfaces (“APIs”) that allow service providers, such as media streaming service providers, social network service providers, gaming service providers, and the like to monitor network performance data at the application layer level to gain network performance insights and adjust parameters to guarantee specific quality of service. For example, based on packet loss, jitter, and/or network bandwidth, a video service provider can adjust video resolution, adjust buffer settings, and/or adjust retransmission settings to improve video service quality.

The Internet of Things (“IoT”) is a concept of making physical objects, collectively “things,” network addressable to facilitate interconnectivity for the exchange of data. IoT represents a significant business opportunity for service providers, particularly with regard to home devices that monitor and control various aspects of a home environment. While these devices are often marketed as “smart,” these devices do not have access to network performance data that can enable new services, provide greater accuracy to existing services, and to better understand the environment in which they are deployed.

### SUMMARY

Concepts and technologies disclosed herein are directed to enhanced smart home services. According to one aspect of the concepts and technologies disclosed herein, a home gateway device can include a processor and a memory. The memory can include computer-executable instructions that, when executed by the processor, cause the processor to perform operations. In particular, the home gateway device can capture, from a home device, home data associated with home user activity conducted via a fixed communications network. The home device can be an IoT device. For example, the home device can be a smart home device such as a thermostat, a light, a camera, a security device, a smoke alarm, a carbon monoxide alarm, a lock, an appliance, or the like. The home device alternatively can be a media such as a television, a video streaming device, a music streaming device, or a video game device. The home gateway device can determine, based upon the home data, a home data profile. The home gateway device can receive a mobility data profile determined by a mobility data profiler based upon mobility data associated with mobile user activity conducted via a mobile communications network. The home gateway device can determine, based upon the mobility data profile and the home data profile, a policy for the home device. In some embodiments, the home data profile and/or the mobility data profile can be determined, at least in part, using machine learning technology.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating an illustrative operating environment in which aspects of the concepts and technologies disclosed herein can be implemented in accordance with various embodiments of the concepts and technologies described herein.

FIG. 2 is a flow diagram illustrating a method for determining a mobility data profile, according to an illustrative embodiment.

FIG. 3 is a flow diagram illustrating a method for determining a home data profile and determining a policy based upon the home data profile and the mobility data profile, according to an illustrative embodiment.

FIG. 4 is a block diagram illustrating an example IoT device capable of implementing aspects of the embodiments presented herein.

FIG. 5 is a block diagram illustrating an example computer system capable of implementing aspects of the embodiments presented herein.

FIG. 6 is a block diagram illustrating an example mobile device capable of implementing aspects of the embodiments disclosed herein.

FIG. 7 is a diagram illustrating a network, according to an illustrative embodiment.

FIG. 8 is a block diagram illustrating an example machine learning system capable of implementing aspects of the concepts and technologies disclosed herein.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, vehicles, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of the concepts and technologies disclosed herein for enhanced smart home services will be described.

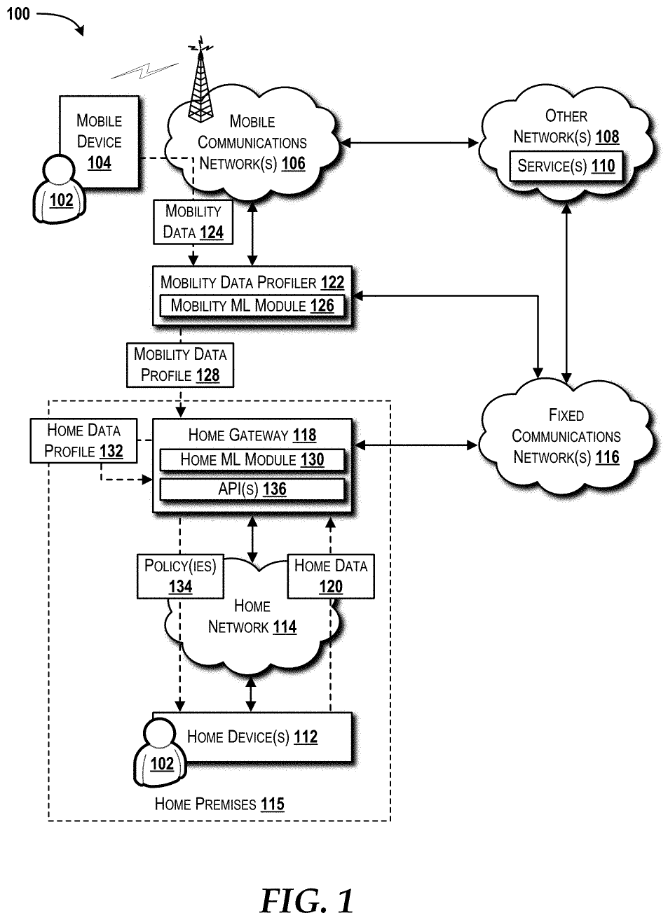

Referring now to FIG. 1, aspects of an illustrative operating environment 100 in which aspects of the concepts and technologies disclosed herein can be implemented will be described. It should be understood that the operating environment 100 and the various components thereof have been greatly simplified for purposes of discussion. Accordingly, additional or alternative components of the operating environment 100 can be made available without departing from the embodiments described herein.

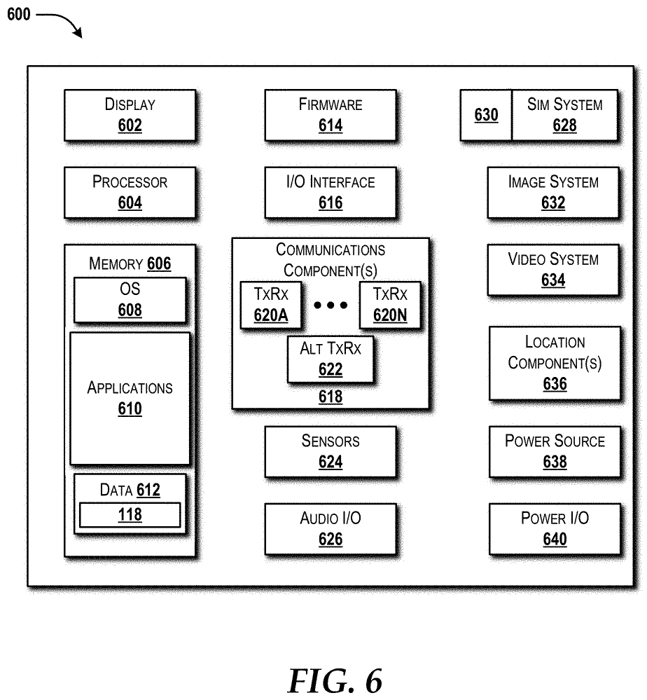

The operating environment 100 includes a user 102 who is associated with a mobile device 104. The mobile device 104 generally can be any computing device that is capable of communicating with one or more mobile communications networks 106. More particularly, the mobile device 104 can be or can include a cellular phone, a feature phone, a smartphone, a mobile computing device, a tablet computing device, a connected vehicle, a “smart” device (e.g., a smartwatch, a fitness tracker device, or the like), a combination thereof, or the like. In some embodiments, the mobile device 104 is configured the same as or similar to a mobile device 600 illustrated and described herein with reference to FIG. 6.

The mobile communications network(s) 106 can be or can include one or more radio access networks (“RANs”; not shown) that can be implemented as a Global System for Mobile communications (“GSM”) RAN (“GRAN”), a GSM Enhanced Data rates for Global Evolution (“EDGE”) RAN (“GERAN”), a Universal Mobile Telecommunications System (“UMTS”) Terrestrial RAN (“UTRAN”), a Evolved UTRAN (“E-UTRAN”), a 5G New Radio (“5G NR”) access network, a virtualized RAN, an open RAN, future generation RANs (e.g., 6G, 7G, etc.), any combination thereof, and/or the like. Moreover, the mobile communications network(s) 106 can utilize various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), future multiple access radio technologies, and/or the like. The mobile communications network(s) 106 also can include one or more core networks (not shown), such as a packet core network, an evolved packet core (“EPC”) network, a 5G core network, a control-plane/user-plane packet network, or a combination thereof. The mobile communications network(s) 106, in turn, can be in communication with one or more other networks 108, such as one or more packet data networks (“PDNs”) and/or the Internet, through which the mobile device 104 can access one or more services 110. The service(s) 110 can be or can include one or more smart home services, as will be described herein.

The user 102 also can be associated with one or more home devices 112 that operate in communication with a home network 114 within a home premises 115. The term “home” is used herein to broadly encompass a location in which the user 102 resides at least part time. As such, the home premises 115 can be a primary residence, a secondary residence, an office or other place of business, or any other location that the user 102 defines as their “home.”

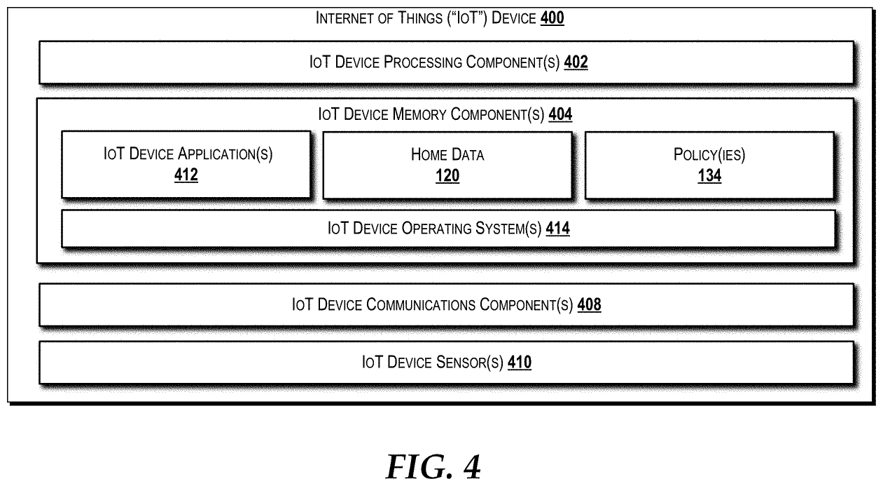

The home device(s) 112 can be or can include one or more IoT devices. In particular, the home device(s) 112 can include one or more smart home devices such as thermostats, lights, cameras, security devices, smoke alarms, carbon monoxide alarms, locks, appliances, and the like. An example IoT device 400 is illustrated and described herein with reference to FIG. 4. The service(s) 110 can be or can include one or more IoT services, which can support the operation of the home device(s) 112 as IoT device(s). For example, the service(s) 110 can enable device setup, device registration, remote monitoring, remote control, and/or other interaction with the home device(s) 112. In some embodiments, the service(s) 110 can be accessed via the mobile device 104, which can execute a corresponding client application to enable the aforementioned functionality. For example, the home device 112 embodied as a smart thermostat may communicate with the service 110 to obtain temperature, humidity, and/or other settings to enable the user 102 to view and manage these settings from a remote device such as the mobile device 104. Those skilled in the art will appreciate that the services 110 can include any services utilized, at least in part, by the mobile device 104 and/or the home device(s) 112. Accordingly, the example services 110 described herein should not be construed as being limiting in any way.

The home device(s) 112 can additionally or alternatively include one or more media devices. A media device can be or can include a video device, an audio device, a video game device, a set-top box, or other device configured to output media that the user 102 can consume. As a media device, the home device 112 can use physical media, including hard disk drive, solid state drive, optical disc-based media, cartridge-based media, proprietary media, a combination thereof, and/or the like. As a media device, the home device 112 additionally or alternatively can be a streaming device that can stream video (e.g., movies, television shows, user-created video content, and the like), audio (e.g., music, podcasts, and the like), games (e.g., via a cloud-based gaming service), a combination thereof, and/or the like. The service(s) 110 can be or can include one or more video, audio, and/or game streaming services.

The home device(s) 112 can communicate directly with the home network 114 (e.g., via an on-board ethernet and/or WIFI component). The home device(s) 112 additionally or alternatively can communicate with the home network 114 through a hub device (not shown), which can communicate with the home device(s) 112 via a wireless technology such as Institute of Electrical and Electronics Engineers (“IEEE”) 802.15.1 (commonly known as BLUETOOTH low energy or BLE), IEEE 802.11ah (HaLow), BLUETOOTH, ZIGBEE, Z-WAVE, other short-range communications technologies, other IoT-specific technologies, combinations thereof, and the like. The home devices 112 can communicate with each other using the same or similar technologies as those described above. It should be understood that as IoT technologies continue to mature, new communications protocols likely will be developed and improve upon existing technologies. The concepts and technologies disclosed herein are not limited to any particular technology(ies). Accordingly, the example technologies described herein should not be construed as being limiting in any way.

The home network 114 can be or can include one or more local area networks (“LANs”), including one or more wireless LANs (“WLANs”) and/or one or more wired/fixed LANs (e.g., ethernet). The home network 114 can communicate with one or more fixed communications networks 116 via a home gateway 118. The fixed communications network(s) 116 can be or can include one or more fixed broadband communications networks implemented via fiber optic, coaxial cable, digital subscriber line (“DSL”), broadband over power lines, a combination thereof, and/or the like. The home gateway 118 can be or can include a modem that enables connectivity to the fixed communications network(s) 118. The home gateway 118 additionally can provide other functionality such as routing, switching, and the like for the home device(s) 112. Aspects of the home gateway 118 can be enabled via firmware, software, hardware, or some combination thereof. In some embodiments, the home gateway 118 operates as a standalone device that is in communication with an existing modem, router, switch, or other network device. In some other embodiments, the home gateway 118 operates as a piggyback device that communicates directly with an existing modem, router, switch, or other network device. The home gateway 118 alternatively may be a proprietary device that provides the functionality described herein.

The home gateway 118 can capture home data 120 from one or more of the home device(s) 112. The home data 120 can include any data associated with the operation and/or usage of the home device(s) 112, including data associated with interactions with the user 102 (referred to herein as “home user activity”), interactions with other home device(s) 112, interactions with the service(s) 110, other interactions, or a combination thereof. More particularly, the home data 120 can include data associated with user activity while the user 102 is using the home device(s) 112 via the fixed communications network(s) 116 to access the service(s) 110.

The home data 120 can include time data indicative of when the home device(s) 112 are used. For example, the home data 120 can include time data indicative of a duration of usage (e.g., per session and/or total usage), any schedule associated with the usage (e.g., thermostat schedule, door lock schedule, alarm schedule, other IoT device schedule, typical television viewing schedule, other media device usage schedule, or the like), a routine that can be determined from the usage, and/or other time data associated with the home device(s) 112. The home data 120 can include network performance data associated with the home device(s) 112. For example, the home data 120 can include bandwidth data, throughput data, latency data, jitter data, error rate data, a combination thereof, and/or the like associated with the home device(s) 110. The home data 120 can include Internet traffic data, such as, for example, web sites visited by the user 102 and from which of the home device(s) 112, traffic volume data, a combination thereof, and/or the like. The home data 120 can include media data that identifies one or more media streaming services (e.g., video and/or music streaming services), media type, specific media titles (e.g., movie title, show title, artist, album title, song title, and/or the like), a combination thereof, and/or the like.

The home gateway 118 also can communicate with a mobility data profiler 122 via the fixed communications network(s) 116 and/or the other network(s) 108. The mobility data profiler 122 can capture mobility data 124 from the mobile device 104 and/or the mobile communications network(s) 106. The mobility data 124 can include any data associated with the operation and/or usage of the mobile device 104, including data associated with interactions with the user 102 (referred to herein as “mobile user activity”), interactions with other mobile devices (not shown), interactions with the service(s) 110, other interactions, location data (e.g., network-based, GPS-based, or network-assisted GPS-based), movement direction, movement speed, network performance data (e.g., data, throughput data, latency data, jitter data, error rate data, wireless connection data), a combination thereof, and/or the like associated with the mobile device 104. The mobility data 124 can include Internet traffic data, such as, for example, websites visited by the user 102 and from which of the mobile device 104, traffic volume data, a combination thereof, and/or the like.

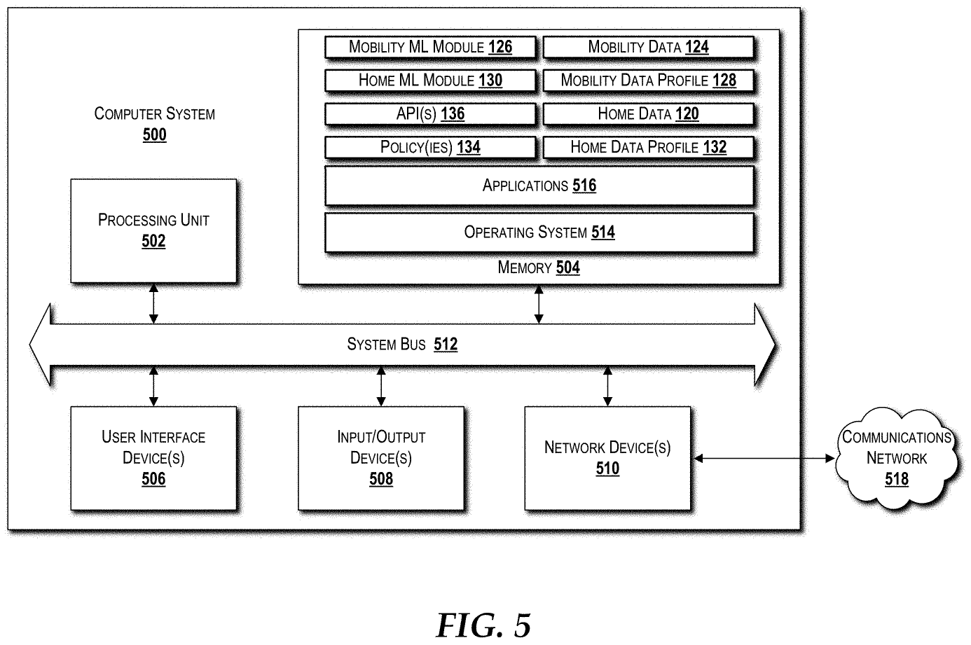

The mobility data profiler 122 can execute, via one or more processors (best shown in FIG. 5), a mobility machine learning module 126 to determine a mobility data profile 128 based, at least in part, upon the mobility data 124. The mobility data profile 128 can identify the location(s) frequented by the user 102, the time spent at the location(s), the network performance experienced by the mobile device 104 at the location(s), and/or the application(s) (e.g., IoT application) executed by the mobile device 104 at the location(s). The mobility data profile 128 can include identify application usage in terms of time used and/or data used. The mobility data profile 128 can include data traffic volume at different times of the day, week, month, and/or year. The mobility data profiler 122 can provide the mobility data profile 128 to the home gateway 118 via the fixed communications network(s) 116. The mobility data profile 128 can update the mobility data profile 128 as needed.

The home gateway 118 can execute, via one or more processors (best shown in FIG. 5), a home machine learning module 130 to determine a home data profile 132 from the home data 120. The home gateway 118 can determine, based upon the mobility data profile 128 and the home data profile 132, one or more policies 134. The home gateway 118 can provide the policies 134 to the home device(s) 112 for implementation. The policies 134 can be generic to all of the home devices 112. The policies 134 can be device type specific (e.g., IoT versus media). The policies 134 can be device functionality specific (e.g., a thermostat device versus an alarm device). The policies 134 can be device specific (e.g., applied based upon the MAC address, serial number, IP address, or other unique identifier). The policies 134 can include quality of service (“QoS”) policies. The policies 134 can include user-defined policies. The policies 134 can include provider-defined policies (e.g., mobile network operator and/or Internet service provider). The policies 134 can be data traffic specific (e.g., video streaming versus multiplayer gaming versus web browsing). For example, one or more of the policies 134 can prioritize gaming traffic over other types of traffic. In this example, the policies 134 can be used to reduce latency and jitter by prioritizing gaming traffic over other traffic, such as background traffic, that can be smoothed in accordance with the policies 134.

In some embodiments, the home gateway 118 can expose one or more API(s) 136 through which the home device(s) 112 can share the home data 120 and receive the policies 134. The policies 134 can be cancelled, new policies 134 can be added, and/or the policies 134 can be modified over time. In some embodiments, the policies 134 can be overridden by the user 102 and/or a network operator (e.g., a mobile network operator or a fixed network operator).

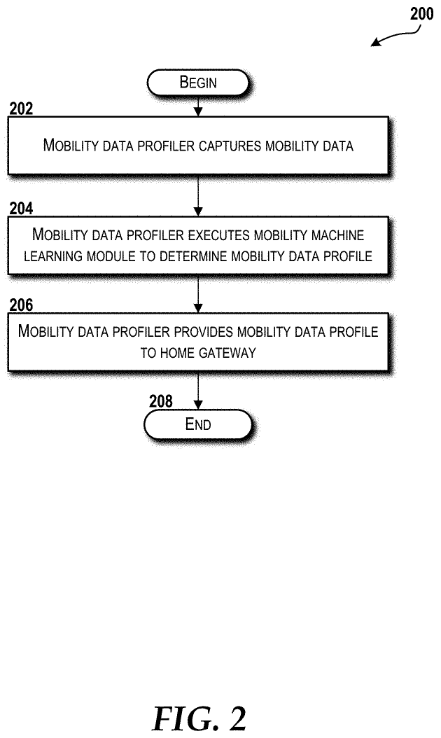

Turning now to FIG. 2, a method 200 for determining a mobility data profile 128 will be described, according to an illustrative embodiment. It should be understood that the operations of the method disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems or devices, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing one or more processors, or components thereof, and/or one or more other computing systems, network components, and/or devices disclosed herein, and/or virtualizations thereof, to perform operations.

For purposes of illustrating and describing some of the concepts of the present disclosure, the methods 200, 300 will be described as being performed, at least in part, by the home gateway 118 or the mobility data profiler 122. It should be understood that additional and/or alternative devices can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the mobility data profiler 122 captures mobility data 124. The mobility data 124 can include any data associated with the operation and/or usage of the mobile device 104, including data associated with interactions with the user 102 (referred to herein as “mobile user activity”), interactions with other mobile devices (not shown), interactions with the service(s) 110, other interactions, location data (e.g., network-based, GPS-based, or network-assisted GPS-based), movement direction, movement speed, network performance data (e.g., data, throughput data, latency data, jitter data, error rate data, wireless connection data), a combination thereof, and/or the like associated with the mobile device 104. The mobility data 124 can include Internet traffic data, such as, for example, websites visited by the user 102, traffic volume data, a combination thereof, and/or the like.

From operation 202, the method 200 proceeds to operation 204. At operation 204, the mobility data profiler 122 executes the mobility machine learning module 126 to determine the mobility data profile 128. The mobility machine learning module 126 can implement a long short-term memory (“LSTM”) neural network, seasonal autoregressive integrated moving average (“SARIMA”), or other machine learning model to determine the mobility data profile 128. For example, the mobility machine learning module 126 can use LSTM or SARIMA to build the user's video traffic usage for the time of day. From operation 204, the method 200 proceeds to operation 206. At operation 206, the mobility data profiler 122 provides the mobility data profile 128 to the home gateway 118.

From operation 206, the method 200 proceeds to operation 208. The method 200 can end at operation 208.

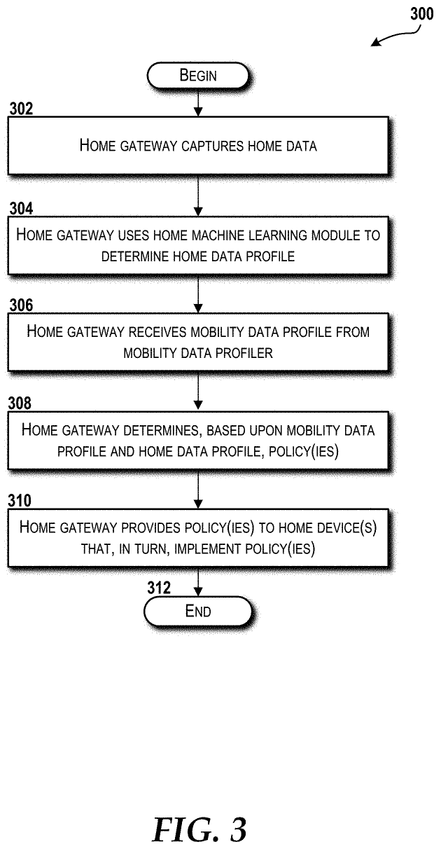

Turning now to FIG. 3, a method 300 for determining a home data profile 132 and determining a policy 134 based upon the home data profile 132 and the mobility data profile 128 will be described, according to an illustrative embodiment. The method 300 begins and proceeds to operation 302. At operation 302, the home gateway 118 captures the home data 120 associated with home user activity. From operation 302, the method 300 proceeds to operation 304. At operation 304, the home gateway 118 uses the home machine learning module 130 to determine the home data profile 132. The home machine learning module 130 can implement LSTM, SARIMA, or other machine learning model to determine the home data profile 132. For example, the home machine learning module 130 can use LSTM or SARIMA to build the user's video traffic usage for the time of day.

From operation 304, the method 300 proceeds to operation 306. At operation 306, the home gateway 118 receives the mobility data profile 128 from the mobility data profiler 122. From operation 306, the method 300 proceeds to operation 308. At operation 308, the home gateway 118 determines, based upon the mobility data profile 128 and the home data profile 132, one or more policies 134. From operation 308, the method 300 proceeds to operation 310. At operation 310, the home gateway 118 provides the policy(ies) 134 to the home device(s) 112 that, in turn, implement the policy(ies) 134.

From operation 310, the method 300 proceeds to operation 312. The method 300 can end at operation 312.

Turning now to FIG. 4, a block diagram illustrating aspects of an example IoT device 400 and components thereof capable of implementing aspects of the embodiments presented herein will be described. In some embodiments, one or more of the home devices 112 is/are configured similar to or the same as the IoT device 400. While connections are not shown between the various components illustrated in FIG. 4, it should be understood that some, none, or all of the components illustrated in FIG. 4 can be configured to interact with one another to carry out various device functions. In some embodiments, the components are arranged so as to communicate via one or more busses (not shown). Thus, it should be understood that FIG. 4 and the following description are intended to provide a general understanding of a suitable environment in which various aspects of embodiments can be implemented, and should not be construed as being limiting in any way.

The illustrated IoT device 400 includes one or more IoT device processing components 402, one or more IoT device memory components 404, one or more IoT device communications components 408, and one or more IoT device sensors 410. The IoT device processing components 402 can include one or more hardware components that perform computations to process data, and/or to execute computer-executable instructions of one or more application programs such as one or more IoT device application(s) 412, one or more IoT device operating system(s) 414, and/or other software. The IoT device processing component(s) 402 can include one or more CPUs configured with one or more processing cores. The IoT device processing component(s) 402 can include one or more GPU configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the IoT device processing component(s) 402 can include one or more discrete GPUs. In some other embodiments, the IoT device processing component(s) 402 can include CPU and GPU components that are configured in accordance with a co-processing CPU/GPU computing model, wherein the sequential part of an application executes on the CPU and the computationally-intensive part is accelerated by the GPU. The IoT device processing component(s) 402 can include one or more system on a chip (“SoC”) components along with one or more other components illustrated as being part of the IoT device 400, including, for example, the IoT device memory component 404, the IoT device communications component(s) 408, the IoT device sensor(s) 410, or some combination thereof. In some embodiments, the IoT device processing component(s) 402 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more OMAP SoCs, available from TEXAS INSTRUMENTS of Dallas, Tex.; one or more customized versions of any of the above SoCs; and/or one or more proprietary SoCs. The IoT device processing component(s) 402 can be or can include one or more hardware components architected in accordance with an ARM architecture, available for license from ARM HOLDINGS of Cambridge, United Kingdom. Alternatively, the IoT device processing component(s) 402 can be or can include one or more hardware components architected in accordance with an x86 architecture, such an architecture available from INTEL CORPORATION of Mountain View, Calif., and others. Those skilled in the art will appreciate the implementation of the IoT device processing component(s) 402 can utilize various computation architectures, and as such, the IoT device processing component(s) 402 should not be construed as being limited to any particular computation architecture or combination of computation architectures, including those explicitly disclosed herein.

The IoT device memory component(s) 404 can include one or more hardware components that perform storage operations, including temporary or permanent storage operations. In some embodiments, the IoT device memory component(s) 404 can include volatile and/or non-volatile memory implemented in any method or technology for storage of information such as computer-readable instructions, data structures, program modules, the IoT device operating system(s) 414, the IoT device application(s) 412, at least a portion of the home data 120, one or more policies 134, combinations thereof, and/or other data disclosed herein. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store data and which can be accessed by the IoT device processing component(s) 402.

The IoT device application(s) 412 can be executed by the IoT device processing component(s) 402 to perform various IoT operations. For example, the IoT device application(s) 412 can instruct the IoT device sensor(s) 410 to collect data and share the data with the service(s) 110. The IoT device application(s) 412 can execute on top of the IoT device operating system(s) 414. In some embodiments, the IoT device application(s) 412 can be provided as firmware.

The IoT device operating system(s) 414 can control the operation of the IoT device 400. In some embodiments, the IoT device operating system(s) 414 includes the functionality of the IoT device application(s) 412. The IoT device operating system(s) 414 can be executed by the IoT device processing component(s) 402 to cause the IoT device 400 to perform various operations. The IoT device operating system(s) 414 can include a member of the SYMBIAN OS family of operating systems from SYMBIAN LIMITED, a member of the WINDOWS OS, WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems or a member of the OS X family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The IoT device sensor(s) 410 can include any sensor type or combination of sensor types utilizing any known sensor technology that is capable of detecting one or more characteristics of an environment in which the IoT device 400 is deployed. More particularly, the IoT device sensor(s) 410 can include, but are not limited to, lighting control sensor, appliance control sensor, security sensor, alarm sensor, medication dispenser sensor, entry/exit detector sensor, video sensor, camera sensor, alarm sensor, motion detector sensor, door sensor, window sensor, window break sensor, outlet control sensor, vibration sensor, occupancy sensor, orientation sensor, water sensor, water leak sensor, flood sensor, temperature sensor, humidity sensor, smoke detector sensor, carbon monoxide detector sensor, doorbell sensor, dust detector sensor, air quality sensor, light sensor, gas sensor, fall detector sensor, weight sensor, blood pressure sensor, IR sensor, HVAC sensor, smart home sensor, thermostats, other security sensors, other automation sensors, other environmental monitoring sensors, other healthcare sensors, multipurpose sensor that combines two or more sensors, the like, and/or combinations thereof. Those skilled in the art will appreciate the applicability of the IoT device sensors 410 to various aspects of the services 110, and for this reason, additional details in this regard are not provided.

The IoT device communications component(s) 408 can include an RF transceiver or separate receiver and transmitter components. The IoT device communications component 408 can include one or more antennas and one or more RF receivers for receiving RF signals from and one or more RF transmitters for sending RF signals to other IoT devices 400 (e.g., the home devices 112), the home network 114, and/or the home gateway 118. It is contemplated that the IoT device communications component(s) 408 also may include a wired connection to the home network 114.

Turning now to FIG. 5, a computer system 500 and components thereof will be described. An architecture similar to or the same as the computer system 500 can be used to implement various systems/devices disclosed herein, such as one or more of the home devices 112, the home gateway 118, the mobility data profiler 122, one or more systems/devices associated with the home network 114, one or more systems/devices associated with the mobile communications network(s) 106, one or more systems/devices associated with the other network(s) 108, one or more systems/devices associated with the service(s) 110, one or more systems/devices associated with the fixed communications network(s) 116, and/or other systems/devices that can be used along with or in support of the concepts and technologies disclosed herein.

The computer system 500 includes a processing unit 502, a memory 504, one or more user interface devices 506, one or more input/output (“I/O”) devices 508, and one or more network devices 510, each of which is operatively connected to a system bus 512. The system bus 512 enables bi-directional communication between the processing unit 502, the memory 504, the user interface devices 506, the I/O devices 508, and the network devices 510.

The processing unit 502 might be a standard central processor that performs arithmetic and logical operations, a more specific purpose programmable logic controller (“PLC”), a programmable gate array, or other type of processor known to those skilled in the art and suitable for controlling the operation of the computer system 500. Processing units are generally known, and therefore are not described in further detail herein.

The memory 504 communicates with the processing unit 502 via the system bus 512. In some embodiments, the memory 504 is operatively connected to a memory controller (not shown) that enables communication with the processing unit 502 via the system bus 512. The illustrated memory 504 includes an operating system 514 and one or more applications 516. The memory 504 in the illustrated example can include, as appropriate, the mobility machine learning module 126, the home machine learning module 130, the API(s) 136, the policy(ies) 134, the mobility data 124, the mobility data profile 128, the home data 120, and the home data profile 132.

The operating system 514 can include, but is not limited to, members of the WINDOWS family of operating systems from MICROSOFT CORPORATION, the LINUX family of operating systems, the BREW family of operating systems from QUALCOMM CORPORATION, the MAC OS and/or iOS families of operating systems from APPLE INC., the FREEBSD family of operating systems, the SOLARIS family of operating systems from ORACLE CORPORATION, other operating systems such as proprietary operating systems, and the like.

The user interface devices 506 may include one or more devices with which a user accesses the computer system 500. The user interface devices 506 may include, but are not limited to, computers, servers, personal digital assistants, telephones (e.g., cellular, IP, or landline), or any suitable computing devices. The I/O devices 508 enable a user to interface with the program modules. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, a touchscreen, or an electronic stylus. Further, the I/O devices 508 may include one or more output devices, such as, but not limited to, a display screen or a printer. An I/O device 508 embodied as a display screen can be used to present information.

The network devices 510 enable the computer system 500 to communicate with a communications network 518, which can include the mobile communications network(s) 106, the other network(s) 108, the fixed communications network(s) 116, or a combination thereof. Examples of the network devices 510 include, but are not limited to, a modem, a radio frequency (“RF”) or infrared (“IR”) transceiver, a telephonic interface, a bridge, a router, or a network card. The network 518 may include a wireless network such as, but not limited to, a WLAN such as a WI-FI network, a WWAN, a wireless PAN (“WPAN”) such as BLUETOOTH, or a wireless MAN (“WMAN”). Alternatively, the network 518 may be a wired network such as, but not limited to, a WAN such as the Internet, a LAN such as the Ethernet, a wired PAN, or a wired MAN.

Turning now to FIG. 6, an illustrative mobile device 600 and components thereof will be described. In some embodiments, the mobile device 104 described herein can be configured similar to or the same as the mobile device 600. While connections are not shown between the various components illustrated in FIG. 6, it should be understood that some, none, or all of the components illustrated in FIG. 6 can be configured to interact with one another to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a display 602 for displaying data. According to various embodiments, the display 602 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 600 also can include a processor 604 and a memory or other data storage device (“memory”) 606. The processor 604 can be configured to process data and/or can execute computer-executable instructions stored in the memory 606. The computer-executable instructions executed by the processor 604 can include, for example, an operating system 608, one or more applications 610, other computer-executable instructions stored in the memory 606, or the like. In some embodiments, the applications 610 also can include a UI application (not illustrated in FIG. 6).

The UI application can interface with the operating system 608 to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in entering/deleting data, entering and setting user IDs and passwords for device access, configuring settings, manipulating content and/or settings, multimode interaction, interacting with other applications 610, and otherwise facilitating user interaction with the operating system 608, the applications 610, and/or other types or instances of data 612 that can be stored at the mobile device 600.

The applications 610, the data 612, and/or portions thereof can be stored in the memory 606 and/or in a firmware 614, and can be executed by the processor 604. In the illustrated example, the applications 610 can include one or more IoT applications, one or more media applications, and/or other applications associated with the service(s) 110. It can be appreciated that the firmware 614 can be stored in a volatile or non-volatile data storage device including, but not limited to, the memory 606 and/or a portion thereof.

The mobile device 600 also can include an input/output (“I/O”) interface 616. The I/O interface 616 can be configured to support the input/output of data such as location information, presence status information, user IDs, passwords, and application initiation (start-up) requests. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 also can include a communications component 618. The communications component 618 can be configured to interface with the processor 604 to facilitate wired and/or wireless communications with one or more networks, such as the mobile communications network(s) 106, the other network(s) 108, the fixed communications network(s) 110, or some combination thereof. In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments, one or more of the transceivers of the communications component 618 may be configured to communicate using GSM, CDMA CDMAONE, CDMA2000, LTE, and various other 2G, 2.6G, 3G, 4G, 4.5G, 5G, 6G, 7G, and greater generation technology standards. Moreover, the communications component 618 may facilitate communications over various channel access methods (which may or may not be used by the aforementioned standards) including, but not limited to, TDMA, FDMA, W-CDMA, OFDMA, SDMA, and the like.

In addition, the communications component 618 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 618 can include a first transceiver (“TxRx”) 620A that can operate in a first communications mode (e.g., GSM). The communications component 618 also can include an N^{th} transceiver (“TxRx”) 620N that can operate in a second communications mode relative to the first transceiver 620A (e.g., UMTS). While two transceivers 620A-620N (hereinafter collectively and/or generically referred to as “transceivers 620”) are shown in FIG. 6, it should be appreciated that less than two, two, and/or more than two transceivers 620 can be included in the communications component 618.

The communications component 618 also can include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, infrared, infrared data association (“IRDA”), near field communications (“NFC”), other RF technologies described herein, variations thereof, combinations thereof, and the like. In some embodiments, the communications component 618 also can facilitate reception from terrestrial radio networks, digital satellite radio networks, internet-based radio service networks, combinations thereof, and the like. The communications component 618 can process data from one or more networks such as the mobile communications network(s) 106, the other network(s) 108, the fixed communications network(s) 116, the Internet, an intranet, a broadband network, a WIFI hotspot, an Internet service provider (“ISP”), a digital subscriber line (“DSL”) provider, a broadband provider, combinations thereof, or the like.

The mobile device 600 also can include one or more sensors 624. The sensors 624 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices.

The illustrated mobile device 600 also can include a subscriber identity module (“SIM”) system 628. The SIM system 628 can include a universal SIM (“USIM”), a universal integrated circuit card (“UICC”) and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Because other devices and/or modules for identifying users and/or the mobile device 600 are contemplated, it should be understood that these embodiments are illustrative, and should not be construed as being limiting in any way.

The mobile device 600 also can include an image capture and processing system 632 (“image system”). The image system 632 can be configured to capture or otherwise obtain photos, videos, and/or other visual information. As such, the image system 632 can include cameras, lenses, charge-coupled devices (“CCDs”), combinations thereof, or the like. The mobile device 600 may also include a video system 636. The video system 636 can be configured to capture, process, record, modify, and/or store video content. Photos and videos obtained using the image system 632 and the video system 634, respectively, may be added as message content to an MMS message, email message, and sent to another device. The video and/or photo content also can be shared with other devices via various types of data transfers via wired and/or wireless communication devices as described herein.

The mobile device 600 also can include one or more location components 636. The location components 636 can be configured to send and/or receive signals to determine a geographic location of the mobile device 600. According to various embodiments, the location components 636 can send and/or receive signals from global positioning system (“GPS”) devices, assisted-GPS (“A-GPS”) devices, WI-FI/WIMAX and/or cellular network triangulation data, combinations thereof, and the like. The location component 636 also can be configured to communicate with the communications component 618 to retrieve triangulation data for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 also can include a power source 638. The power source 638 can include one or more batteries, power supplies, power cells, and/or other power subsystems including alternating current (“AC”) and/or direct current (“DC”) power devices. The power source 638 also can interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 600 or other devices or computers described herein, such as the IoT device 400 and the computer system 500 described above with reference to FIGS. 4 and 5, respectively. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 600 in order to store and execute the software components presented herein. It is also contemplated that the mobile device 600 may not include all of the components shown in FIG. 6, may include other components that are not explicitly shown in FIG. 6, or may utilize an architecture completely different than that shown in FIG. 6.

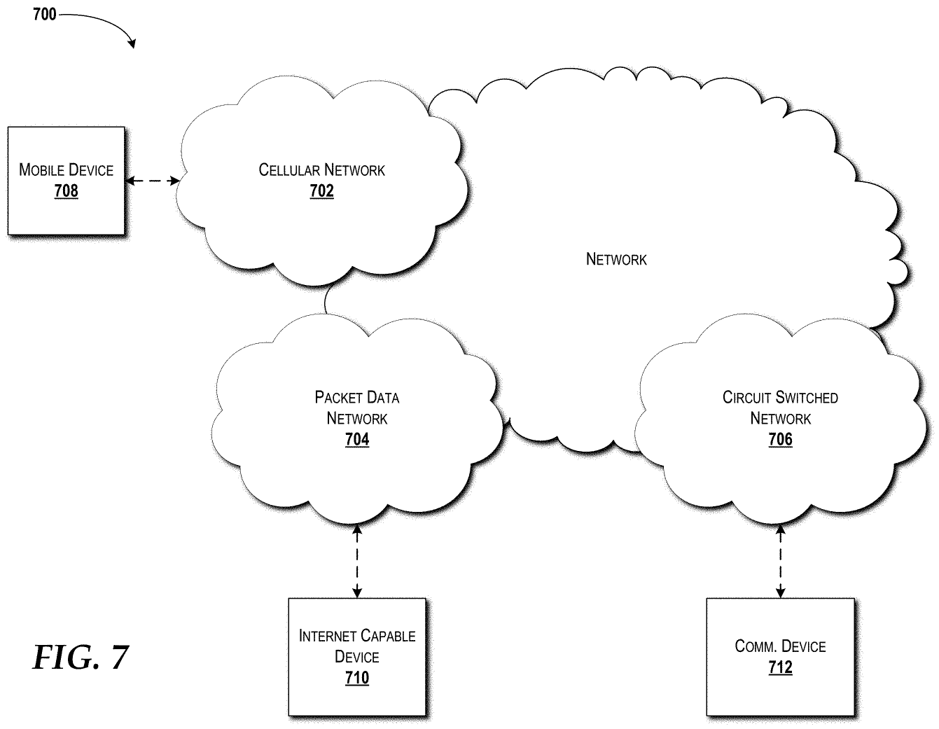

Turning now to FIG. 7, details of a network 700 are illustrated, according to an illustrative embodiment. The illustrated network 700 includes a cellular network 702 (e.g., the mobile communications network(s) 106), a packet data network 704 (e.g., the other network(s) 108 and/or the fixed communications network(s) 116), and a circuit switched network 706. The cellular network 702 can include various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the mobile device 104, a cellular telephone, a user equipment, a PDA, a laptop computer, a handheld computer, and combinations thereof, can be operatively connected to the cellular network 702. The mobile communications device 708 can be configured similar to or the same as the mobile device 600 described above with reference to FIG. 6.

The cellular network 702 can be configured as a GSM network and can provide data communications via GPRS and/or EDGE. Additionally, or alternatively, the cellular network 702 can be configured as a 3G Universal Mobile Telecommunications System (“UMTS”) network and can provide data communications via the HSPA protocol family, for example, HSDPA, EUL, and HSPA+. The cellular network 702 also is compatible with 4G mobile communications standards such as LTE, 5G mobile communications standards, or the like, as well as evolved and future mobile standards.

The packet data network 704 includes various systems, devices, servers, computers, databases, and other devices in communication with one another, as is generally known. In some embodiments, the packet data network 704 is or includes one or more WIFI networks, each of which can include one or more WIFI access points, routers, switches, and other WIFI network components. The packet data network 704 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 704 includes or is in communication with the Internet.

The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710 such as a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

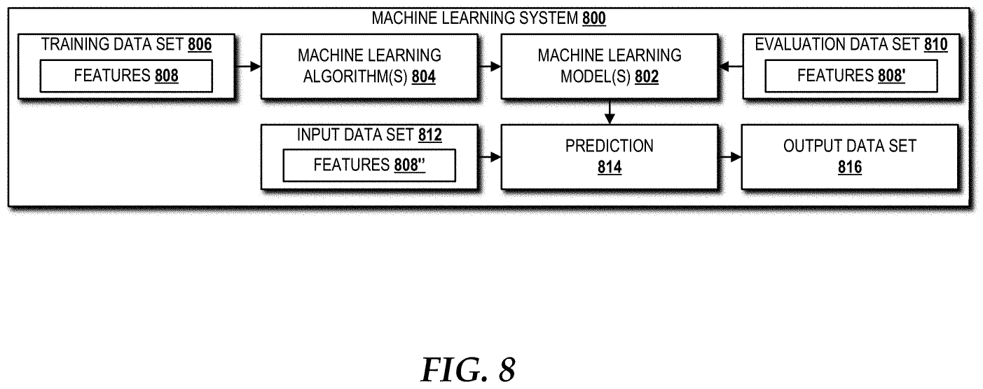

Turning now to FIG. 8, a machine learning system 800 capable of implementing aspects of the embodiments disclosed herein will be described. In some embodiments, aspects of the mobility data profiler 122 and/or the home gateway 118 can be improved via machine learning. Accordingly, the mobility data profiler 122 and/or the home gateway 118 can include an instance of the machine learning system 800 implemented as the mobility machine learning module 126 and the home machine learning module 130. Alternatively, the mobility data profiler 122 and/or the home gateway 118 can be in communication with the machine learning system 800 or multiple instances thereof that, in turn, executes the mobility machine learning module 126 and/or the home machine learning module 130. As such, the mobility machine learning module 126 and the home machine learning module 130 can be executed locally or remotely.

The illustrated machine learning system 800 includes one or more machine learning models 802. The machine learning models 802 can include, unsupervised, supervised, and/or semi-supervised learning models. The machine learning model(s) 802 can be created by the machine learning system 800 based upon one or more machine learning algorithms 804. The machine learning algorithm(s) 804 can be any existing, well-known algorithm, any proprietary algorithms, or any future machine learning algorithm. Some example machine learning algorithms 804 include, but are not limited to, neural networks, gradient descent, linear regression, logistic regression, linear discriminant analysis, classification tree, regression tree, Naive Bayes, K-nearest neighbor, learning vector quantization, support vector machines, any of the algorithms described herein, and the like. Classification and regression algorithms might find particular applicability to the concepts and technologies disclosed herein. Those skilled in the art will appreciate the applicability of various machine learning algorithms 804 based upon the problem(s) to be solved by machine learning via the machine learning system 800.

The machine learning system 800 can control the creation of the machine learning models 802 via one or more training parameters. In some embodiments, the training parameters are selected by machine learning modelers at the direction of an enterprise, such as a network operator of the mobile communications network(s) 106 and/or the fixed communications network(s) 116. Alternatively, in some embodiments, the training parameters are automatically selected based upon data provided in one or more training data sets 806. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 804 converges to the optimal weights. The machine learning algorithm 804 can update the weights for every data example included in the training data set 806. The size of an update is controlled by the learning rate. A learning rate that is too high might prevent the machine learning algorithm 804 from converging to the optimal weights. A learning rate that is too low might result in the machine learning algorithm 804 requiring multiple training passes to converge to the optimal weights.

The model size is regulated by the number of input features (“features”) 808 in the training data set 806. A greater the number of features 808 yields a greater number of possible patterns that can be determined from the training data set 806. The model size should be selected to balance the resources (e.g., compute, memory, storage, etc.) needed for training and the predictive power of the resultant machine learning model 802.

The number of training passes indicates the number of training passes that the machine learning algorithm 804 makes over the training data set 806 during the training process. The number of training passes can be adjusted based, for example, on the size of the training data set 806, with larger training data sets being exposed to fewer training passes in consideration of time and/or resource utilization. The effectiveness of the resultant machine learning model 802 can be increased by multiple training passes.

Data shuffling is a training parameter designed to prevent the machine learning algorithm 804 from reaching false optimal weights due to the order in which data contained in the training data set 806 is processed. For example, data provided in rows and columns might be analyzed first row, second row, third row, etc., and thus an optimal weight might be obtained well before a full range of data has been considered. By data shuffling, the data contained in the training data set 806 can be analyzed more thoroughly and mitigate bias in the resultant machine learning model 802.

Regularization is a training parameter that helps to prevent the machine learning model 802 from memorizing training data from the training data set 806. In other words, the machine learning model 802 fits the training data set 806, but the predictive performance of the machine learning model 802 is not acceptable. Regularization helps the machine learning system 800 avoid this overfitting/memorization problem by adjusting extreme weight values of the features 808. For example, a feature that has a small weight value relative to the weight values of the other features in the training data set 806 can be adjusted to zero.

The machine learning system 800 can determine model accuracy after training by using one or more evaluation data sets 810 containing the same features 808′ as the features 808 in the training data set 806. This also prevents the machine learning model 802 from simply memorizing the data contained in the training data set 806. The number of evaluation passes made by the machine learning system 800 can be regulated by a target model accuracy that, when reached, ends the evaluation process and the machine learning model 802 is considered ready for deployment.

After deployment, the machine learning model 802 can perform a prediction operation (“prediction”) 814 with an input data set 812 having the same features 808″ as the features 808 in the training data set 806 and the features 808′ of the evaluation data set 810. The results of the prediction 814 are included in an output data set 816 consisting of predicted data. The machine learning model 802 can perform other operations, such as regression, classification, and others. As such, the example illustrated in FIG. 8 should not be construed as being limiting in any way.

Based on the foregoing, it should be appreciated that concepts and technologies for enhanced smart home services have been disclosed herein. Although the subject matter presented herein has been described in language specific to computer structural features, methodological and transformative acts, specific computing machinery, and computer-readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the subject disclosure.

1. A home gateway device comprising:
a processor; and
a memory comprising computer-executable instructions that, when executed by the processor, cause the processor to perform operations comprising
capturing, from a home device, home data associated with home user activity conducted via a fixed communications network,
determining, based upon the home data, a home data profile,
receiving a mobility data profile determined by a mobility data profiler based upon mobility data associated with mobile user activity conducted via a mobile communications network, and
determining, based upon the mobility data profile and the home data profile, a policy for the home device.

2. The home gateway device of claim 1, wherein capturing, from the home device, the home data associated with the home user activity conducted via the fixed communications network comprises capturing, from an Internet of Things device, the home data associated with the home user activity conducted via the fixed communications network.

3. The home gateway device of claim 1, wherein capturing, from the home device, the home data associated with the home user activity conducted via the fixed communications network comprises capturing, from a media device, the home data associated with the home user activity conducted via the fixed communications network.

4. The home gateway device of claim 1, wherein the operations further comprise providing the policy to the home device.

5. The home gateway device of claim 4, wherein the policy comprises a quality of service policy.

6. The home gateway device of claim 4, wherein the operations further comprise exposing an application programming interface through which the home device can share the home data, and wherein providing the policy to the home device comprises providing the policy to the home device via the application programming interface.

7. The home gateway device of claim 1, wherein determining, based upon the home data, the home data profile comprises applying the home data to a machine learning model, wherein the machine learning model is trained to output the home data profile representative of the home user activity.

8. A method comprising:
capturing, by a home gateway device, from a home device, home data associated with home user activity conducted via a fixed communications network;
determining, by the home gateway device, based upon the home data, a home data profile;
receiving, by the home gateway device, a mobility data profile determined by a mobility data profiler based upon mobility data associated with mobile user activity conducted via a mobile communications network; and
determining, by the home gateway device, based upon the mobility data profile and the home data profile, a policy for the home device.

9. The method of claim 8, wherein capturing, by the home gateway device, from the home device, the home data associated with the home user activity conducted via the fixed communications network comprises capturing, by the home gateway device, from an Internet of Things device, the home data associated with the home user activity conducted via the fixed communications network.

10. The method of claim 8, wherein capturing, by the home gateway device, from the home device, the home data associated with the home user activity conducted via the fixed communications network comprises capturing, by the home gateway device, from a media device, the home data associated with the home user activity conducted via the fixed communications network.

11. The method of claim 8, further comprising providing, by the home gateway device, the policy to the home device.

12. The method of claim 11, wherein the policy comprises a quality of service policy.

13. The method of claim 11, further comprising exposing an application programming interface through which the home device can share the home data, and wherein providing the policy to the home device comprises providing the policy to the home device via the application programming interface.

14. The method of claim 8, wherein determining, based upon the home data, the home data profile comprises applying the home data to a machine learning model, wherein the machine learning model is trained to output the home data profile representative of the home user activity.

15. A computer-readable storage medium comprising computer-executable instructions that, when executed by a processor of a home gateway device, cause the processor to perform operations comprising:
capturing, from a home device, home data associated with home user activity conducted via a fixed communications network;
determining, based upon the home data, a home data profile;
receiving a mobility data profile determined by a mobility data profiler based upon mobility data associated with mobile user activity conducted via a mobile communications network; and
determining, based upon the mobility data profile and the home data profile, a policy for the home device.

16. The computer-readable storage medium of claim 15, wherein capturing, from the home device, the home data associated with the home user activity conducted via the fixed communications network comprises capturing, from an Internet of Things device, the home data associated with the home user activity conducted via the fixed communications network.

17. The computer-readable storage medium of claim 15, wherein capturing, from the home device, the home data associated with the home user activity conducted via the fixed communications network comprises capturing, from a media device, the home data associated with the home user activity conducted via the fixed communications network.

18. The computer-readable storage medium of claim 15, wherein the operations further comprise providing the policy to the home device.

19. The computer-readable storage medium of claim 18, wherein the policy comprises a quality of service policy.

20. The computer-readable storage medium of claim 19, wherein the operations further comprise exposing an application programming interface through which the home device can share the home data, and wherein providing the policy to the home device comprises providing the policy to the home device via the application programming interface.
